(19) United States
(12) Patent Application Publication
(10) Pub. No.: US 2021/0261032 A1
(43) Pub. Date: Aug. 26, 2021

(54) Integrated Truck Hoist Control System

(71) Applicant: Custom Hoists Inc., Ashland, OH (US)

(72) Inventors: Michael A. Hayes, Ashland, OH (US); Stephen T. Hamm, Ashland, OH (US); Richard N. Hiltunen, JR., Ashland, OH (US); Benjamin T. Humrichouser, Ashland, OH (US); Alan C. Nastasi, Ashland, OH (US); Ronald J. Dye, Ashland, OH (US)

(73) Assignee: Custom Hoists Inc., Ashland, OH (US)

(21) Appl. No.: 16/801,656

(22) Filed: Feb. 26, 2020

(51) Int. Cl. B60P 1/16; B60K 35/00; B60P 1/273; B60J 11/00; B60R 1/00

(52) U.S. Cl. CPC B60P 1/16; B60P 1/162; B60K 35/00; B60P 1/273; B60J 11/00; B60R 2300/80; B60K 2370/152; B60K 2370/178; B60K 2370/12; B60R 2300/8066; B60R 1/00

(57) ABSTRACT

A control system for a dump truck or trailer having a telescoping hoist is disclosed. The control system includes an integrated electronic control unit which receives sensor information regarding at least a hydraulic pump, a power take-off, a first inclinometer and a second inclinometer and uses this information to send warning to a user display and to sends control information to at least a hydraulic fluid control valve and optionally other devices on the truck or trailer as well.

### FIELD

This disclosure relates to the field of hoist-operated dump trucks and trailers. More particularly, this disclosure relates to an integrated control system for monitoring and safely operating multiple systems found on a hoist-operated dump truck or trailer.

### BACKGROUND

Dump trucks and dump trailers are emptied by raising or tilting the dump bed and this raising or tilting is typically carried out using a hoist made up of a series of telescoping hoist sections. These hoist sections are extended or retracted hydraulically.

In order to dump a load from the truck or trailer, it is also often necessary to open a tailgate and/or retract a tarp cover which is extended over the dump bed while the truck is in transit. Conventionally, each of these separate systems of the dump truck or trailer is separately controlled via its own set of individual switches or other controls.

Moreover, when emptying a load from the dump bed, care must be taken to ensure that the truck does not become unstable and prone to tipping or rolling over when the dump bed is elevated for load dumping.

It would be desirable, however, to provide an integrated control system for a dump truck or trailer that would allow an operator to control all of the separate systems of the dump truck or trailer through a single integrated control interface. It would also be desirable for that control system to provide improved safety measures to prevent unsafe conditions in which the truck or trailer would be prone to tipping or roll over.

### SUMMARY

The above and other needs are met by a control system for a dump truck or a dump trailer, made in accordance with the present disclosure.

According to one embodiment, the control system includes a truck or a truck trailer and a dump bed which is pivotally attached to a lower portion of the truck or truck trailer. The dump bed has a front portion, a rear portion, a bed floor and a plurality of sidewalls attached to the bed floor.

The control system also includes a dump bed hydraulic hoist which includes a plurality of telescoping hoist sections. The hoist has a first end attached to the truck or truck trailer and a second end attached to the dump bed. Further, the hoist is movable between a retracted position and an extended position in which the dump bed is tipped to facilitate load dumping.

The control system also includes a hydraulic pump in flow communication with a hydraulic fluid control valve for supplying pressurized hydraulic fluid to the hoist. This pump further includes a pump sensor for determining the operating state of the pump. A power take-off is also included for selectively transferring power from a truck powertrain to the hydraulic pump. The power take-off includes a valve to engage with and disengage from the hydraulic pump and further includes a power take-off sensor for determining the operating state of the power take-off;

Also included in the control systems is a first inclinometer attached to the dump bed for determining a tip angle and a roll angle of the dump bed and a second inclinometer attached to the lower portion of the truck or truck trailer for determining longitudinal levelness and transverse levelness of the truck or truck trailer lower portion.

An integrated hoist electronic control unit is also included for receiving sensor information and sending control information based upon the sensor information received. This control unit receives information from the pump sensor, the first inclinometer, and the second inclinometer, and the control unit sends control information to the hydraulic fluid control valve. Also, the control system includes a primary hoist human machine interface capable of receiving information from and sending information to the control unit. The primary human machine interface has a video monitor for displaying information received from the control unit and a plurality of controls for sending information to the control unit.

In some instances, both tip angle information and roll angle information for the dump bed are selectively displayed on the video monitor.

According to certain embodiments, the control unit sends control information to disengage the power take-off from the hydraulic pump, and optionally display a warning message on the video monitor, if the control unit receives information from the second inclinometer indicating that either the longitudinal levelness or the transverse levelness of the truck or truck trailer lower portion exceeds a predetermined maximum longitudinal levelness or maximum transverse levelness.

In certain embodiments, the control system also includes at least one pressure sensor for determining a hydraulic cylinder pressure within the hoist. The control unit receives hydraulic pressure information from this at least one pressure sensor and calculates a percent of cylinder load capacity based upon the hydraulic pressure information. Further, in some instances, the control unit determines a maximum safe dump bed tip angle based upon the longitudinal levelness information, the transverse levelness information, and the percent of cylinder load capacity. The control unit then sends control information to stop flow of hydraulic fluid through the hydraulic fluid control valve, and optionally display a warning message on the video monitor, if the tip angle of the dump bed exceeds the maximum safe dump bed tip angle.

In some instances, the control unit sends control information to disengage the power take-off from the hydraulic pump, and optionally display a warning message on the video monitor, if the control unit receives information from the power take-off sensor indicating that the hydraulic pump is not operating.

According to certain embodiment, the control system also includes a tailgate pivotally attached to the rear portion of the dump bed. This tailgate has a latch which is movable between a locked position and an unlocked position and a latch position sensor for determining the position of the tailgate latch. The control unit receives information from the pump sensor and sends control information to disengage the power take-off from the hydraulic pump, and optionally display a warning message on the video monitor, if the control unit receives information from the latch position sensor indicating that the tailgate latch is in an unlocked position.

In some embodiments, the control system also includes a tarp extendable over the dump bed, at least one elongate arm attached to an end of the tarp, a tarp motor (or in some instances a hand crank) for moving the elongate arm and the tarp from a retracted position to an extended position, and a tarp position sensor for determining the position of the tarp arm. The control unit receives tarp position information from the tarp position sensor and sends control information to the tarp motor. Further, in some instances, the control unit sends control information to disengage the power take-off from the hydraulic pump, and optionally display a warning message on the video monitor, if the control unit receives information from the tarp position sensor indicating that the tarp is in an extended position.

In some instances, the truck or truck trailer includes an air suspension for suspending the lower portion of the truck or truck trailer. In these embodiments, the control system also includes at least one suspension pressure sensor for determining the air suspension air pressure, and the control unit receives air pressure information from the at least one suspension pressure sensor. Moreover, in some instances, the control unit sends control information to disengage the power take-off from the hydraulic pump, and optionally display a warning message on the video monitor, if the control unit receives information the at least one suspension pressure sensor indicating that the air suspension air pressure is either below a predetermined minimum air pressure or above a predetermined maximum air pressure.

In certain embodiments, the control system also includes a backup camera attached to the rear portion of the dump bed and positioned for observing an area behind the truck or truck trailer, wherein the control unit receives images from the backup camera and the images are selectively displayed on the video monitor.

In some embodiments, the control system also includes a load camera attached to the front portion of the dump bed and position for observing a location within the dump bed, wherein the control unit receives images from the load camera and the images are selectively displayed on the video monitor.

According to certain embodiments, the control system also includes a secondary hoist human machine interface capable of wirelessly receiving information from and wirelessly sending information to the control unit, the secondary human machine interface having a plurality of controls for sending information to the control unit.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a perspective view of a hoist-operated dump truck for use in accordance with one embodiment of the present disclosure;

FIG. 2 is a perspective view of a dump truck tailgate latch for use in accordance with one embodiment of the present disclosure;

FIG. 3 is a perspective view of a hoist-operated dump trailer for use in accordance with one embodiment of the present disclosure;

FIG. 4 is a perspective view of a hoist-operated dump trailer for use with another embodiment of the present disclosure;

FIG. 5 is a perspective view of a truck tarp for use in accordance with one embodiment of the present disclosure;

FIG. 6 is a perspective view of an air suspension for use in accordance with one embodiment of the present disclosure;

FIG. 7 is a partially exploded view of a portion of hoist system for use in accordance with one embodiment of the present disclosure;

FIG. 8 is a plan view of a human machine interface in accordance with one embodiment of the present disclosure; and

FIG. 9 is a schematic view of a sensor and control system in accordance with one embodiment of the present disclosure.

### DETAILED DESCRIPTION

The present disclosure provides a control system for a hoist-actuated dump truck or a dump trailer, which provides integrated monitoring and control of multiple sub-systems of the dump truck or trailer.

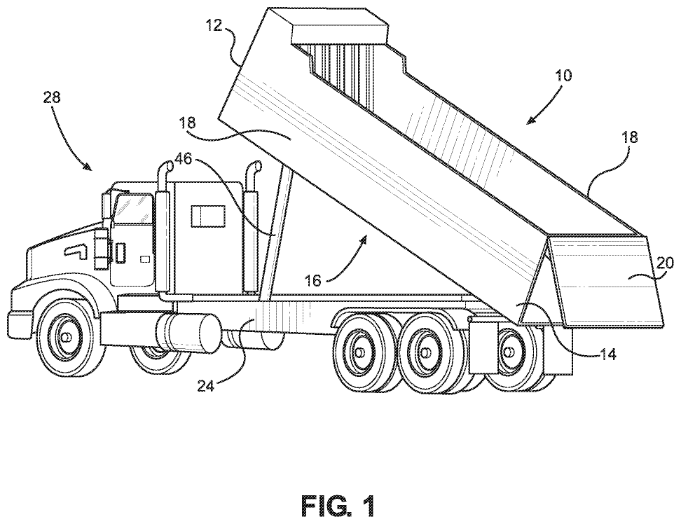

As shown in FIG. 1, the truck or truck trailer includes a dump bed 10 which is pivotally attached to a lower portion 24 of the truck or truck trailer. The dump bed 10 has a front portion 12, a rear portion 14, a bed floor 16 and a plurality of sidewalls 18 attached to the bed floor. A load material such as rock, sand, or scrap metal is deposited into the dump bed 10 for transport. After transport, the load is then dumped from the dump bed 10.

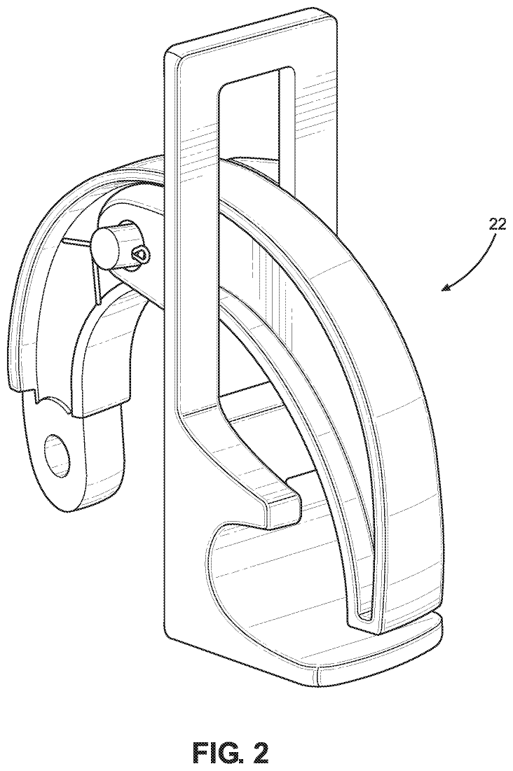

In some instances, the dump bed 10 may be titled sideways in order to side dump the load. In other instances, the front portion 12 of the dump bed 10 is raised and the load is dump from the rear of the dump bed 10. In these instances, typically a tailgate 20 is pivotally attached to the rear portion 14 of the dump bed 10 to facilitate rear load dumping. This tailgate 20 generally has a latch 22, shown in FIG. 2 which is movable between a locked position and an unlocked position. This latch 22 may in some instances be magnetically actuated. More commonly, the latch 22 is manually moved between the locked position and the unlocked position. Also, a latch position sensor is generally included for determining the position (locked or unlocked) of this tailgate latch 22.

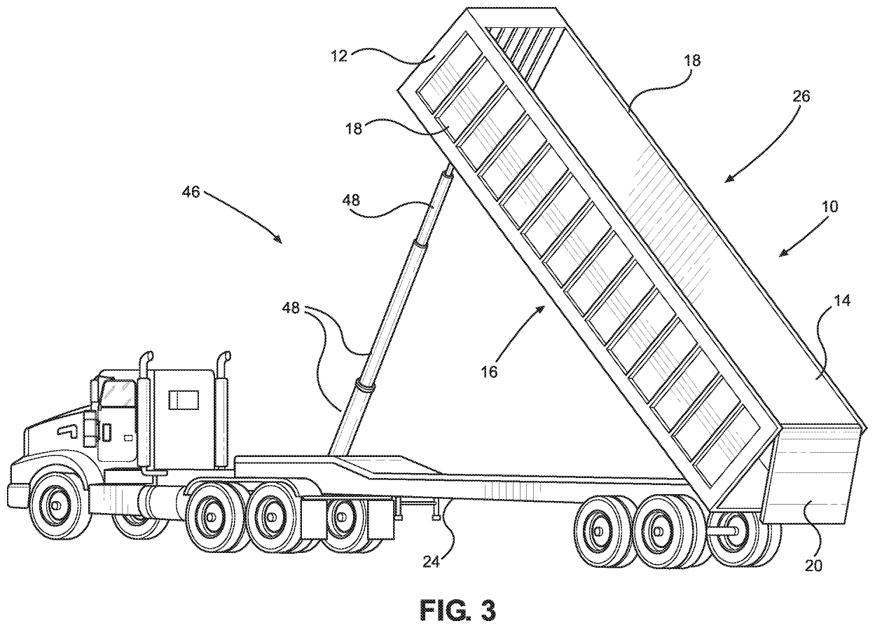

In some embodiments, the dump bed 10 may be attached to a trailer 26, with the trailer 26 in turn being attached to a separate truck for transport, as seen in FIG. 3. In other embodiments, the dump bed 10 may be directly attached to the chassis or frame which makes up the lower portion 24 of a dump truck 28, as seen in FIG. 1.

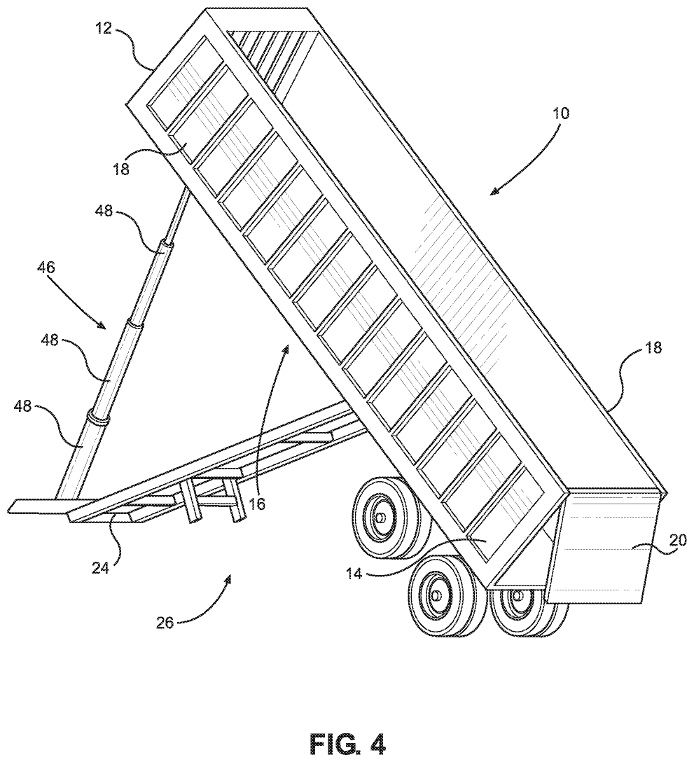

In instances where the dump bed 10 is attached to a trailer, the trailer may be either of the full frame type or of the so-called frameless design. In the full frame design, the lower portion 24 of the trailer includes a chassis or frame extending the full length of the trailer, with the dump bed 10 being pivotally attached to this frame near the rear axles of the trailer, as illustrated in FIG. 3. In the frameless design, the lower portion 24 of the trailer includes one or more arms which extend only a portion of the overall length of the trailer, and the dump bed 10 is pivotally attached to these arms closer to the center of the trailer length, as shown in FIG. 4.

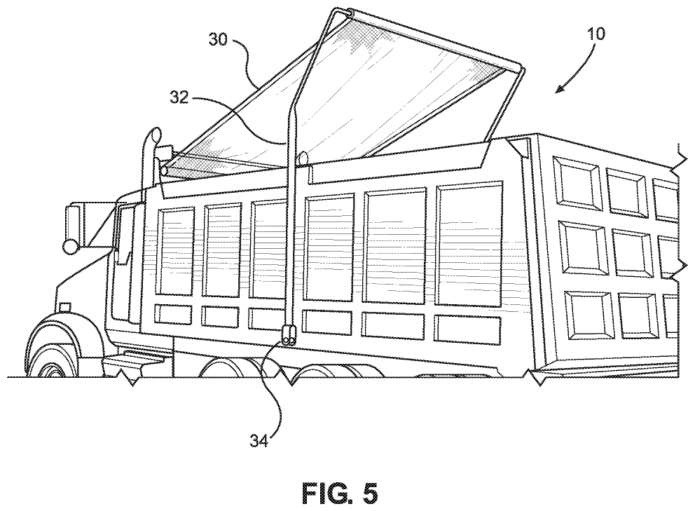

In many instances, a tarp 30 is provided which extends over the dump bed 10, as shown in FIG. 5. The tarp 30 is generally made from a durable fabric material and is used to limit or prevent debris from bouncing out of the dump bed 10 while the truck is in transit from one location to another. The tarp 30 may be extended or retracted. Generally, the tarp 30 is extended during transport and then retracted for load dumping. Generally, an elongate arm 32 is attached to an end of tarp 30 and this arm is moved by a tarp motor 34 (or a manual crank) in order move the tarp between a retracted position and an extended position. A tarp position sensor is also provided which determines whether the tarp 30 is in the extended or retracted position.

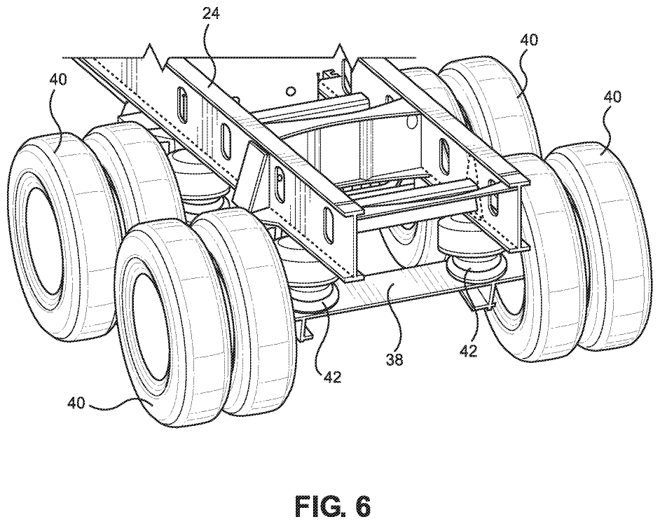

The lower portion 24 of the truck or trailer is also mounted over at least one axle 38 and a plurality of wheels 40 attached to the axle. Typically, the lower portion 24 is connected to the axle or axles 38 by a suspension 42, as shown in FIG. 6. In some instances, this suspension system 42 is an air suspension and the lower portion 24 of the truck or trailer is suspended over the axle or axles 38 by the air suspension 42. In such instances, the air pressure within the air suspension 42 may be varied so as to raise or lower the height of the dump bed 10 above the ground. A sensor is then typically included for determining the air pressure within the air suspension.

The dump bed 10 is lifted and lowered by a dump bed hydraulic hoist 46 which includes a plurality of telescoping hoist sections 48. As seen in FIGS. 1 and 2, the hoist 46 has a first end attached to the truck or truck trailer and a second end attached to the dump bed 10. This hoist 46 is movable between a retracted position (in which the dump bed in lowered) and an extended position in which the dump bed 10 is tipped to facilitate load dumping.

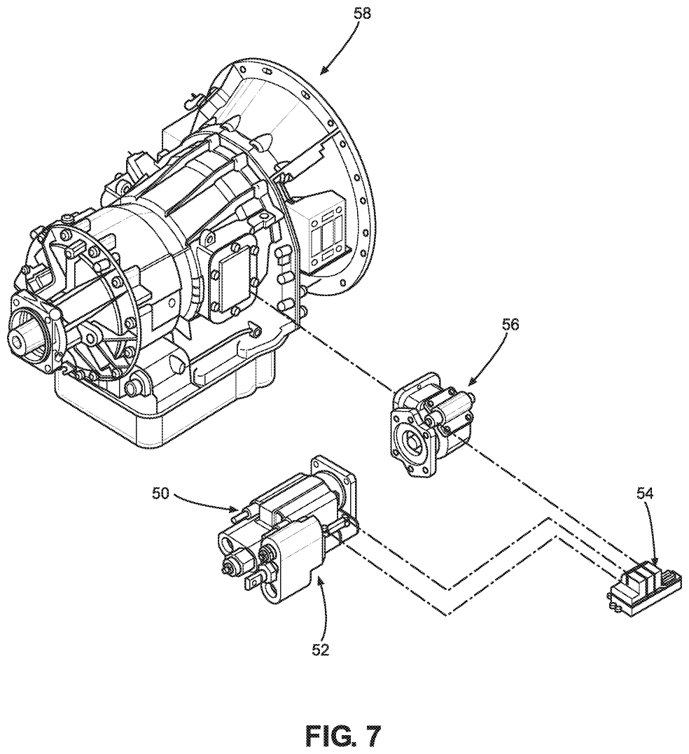

Extension and retraction of the hoist sections 48 is carried out hydraulically. Pressurized hydraulic fluid is supplied to the hoist 46 in order to extend the hoist sections 48, while withdrawal of hydraulic fluid allows for the retraction of the hoist sections 48. This hydraulic fluid is supplied by a hydraulic pump 50 in flow communication with a hydraulic fluid control valve 52, and with a solenoid valve 54, as illustrated in FIG. 7. A pump sensor is also preferably included for determining the operating state of the pump.

A power take-off 56 is used to selectively transfer power from a truck transmission 58 to the hydraulic pump 50. This power take-off 56 includes a valve to engage with and disengage from the hydraulic pump 50. A power take-off sensor is also generally included for determining the operating state of the power take-off 56.

According to the present disclosure, an electronic control unit (ECU) 60 is also included. The electronic control unit 60 includes is located on the truck or trailer.

The electronic control unit 60 includes a microcontroller, as well as a memory device (such as a hard drive, solid state drive, or flash memory) for recording and storing events and data. The electronic control unit 60 also includes a plurality of input/output ports which may be configured for use with a variety of sensors and actuators, as discussed below. In particular, the electronic control unit 60 is capable of providing proportional control outputs.

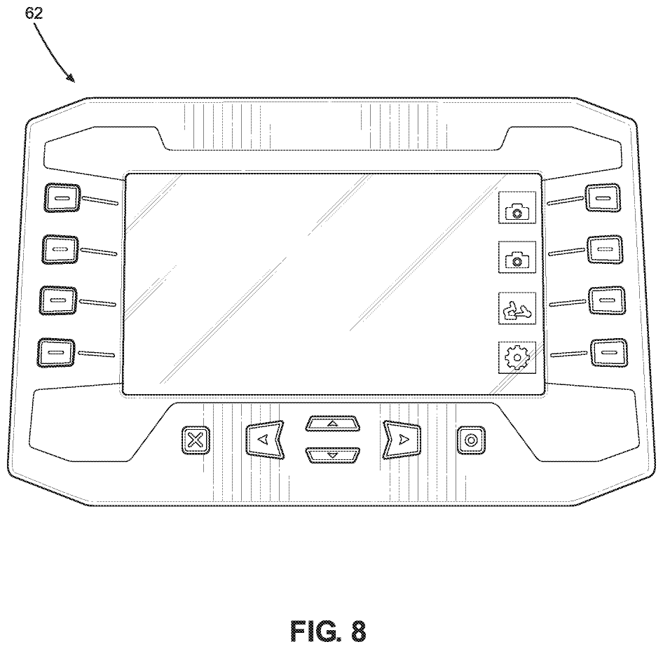

Also, located in or near the cabin of the truck is a human machine interface (HMI) 62 capable which includes multiple interface connections for importing and exporting data from the electronic control unit 60. For instance, the primary human machine interface 62 is a user interface which typically includes at least one video monitor for displaying information received from the control unit 60 and a plurality of selectors (such as physical buttons, soft keys, touchscreens, or switches) for sending information to the control unit 60, as shown in FIG. 8. The video monitor is preferably a color display which is capable of displaying various animated graphics.

Both the electronic control unit 60 and the human machine interface 62 are preferably capable of receiving programming instructions using common programming languages for the off-highway industry such as Codesys or “C”. Both the electronic control unit 60 and the human machine interface 62 are also preferably ruggedized and thus suitable for use in rugged operating conditions (wet, muddy, dusty) as well as both extreme high and low temperatures. Both are also preferably powered by the truck's onboard electrical system.

In some instances, the control system may also include a secondary hoist human machine interface 64. This is typically a handheld unit which may be used by an operator outside of the truck cabin. This secondary human machine interface 64 is capable of wirelessly receiving information from and wirelessly sending information to the control unit 60. The secondary human machine interface 64 typically includes a plurality of controls for sending information to the control unit 60 and may also include a secondary video monitor for displaying information received from the control unit 60.

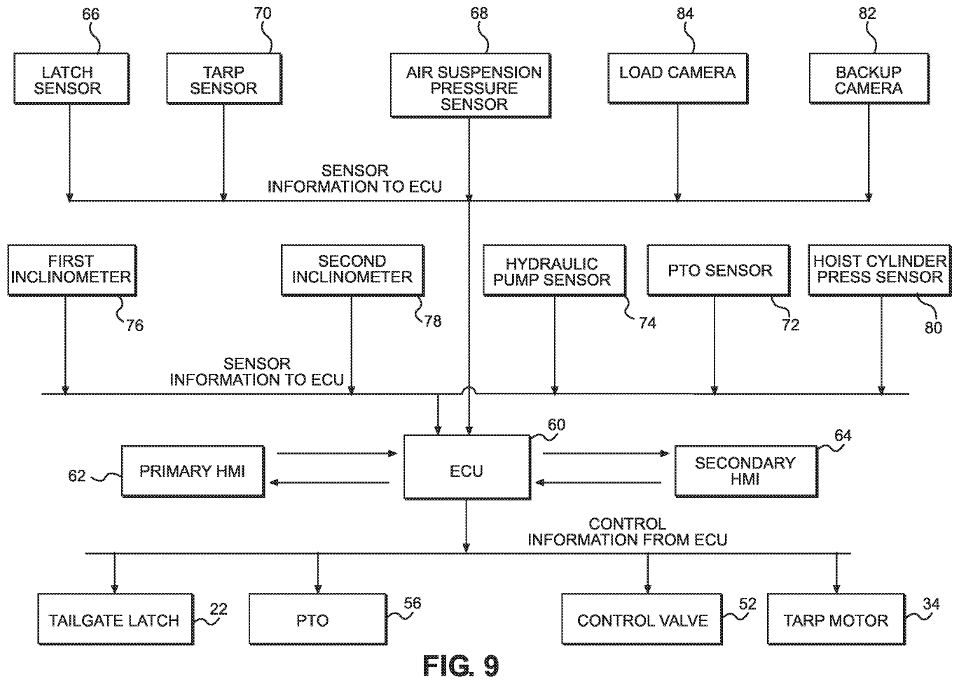

The microcontroller of the hoist control unit 60 receives information (either wirelessly or by hardwiring) from numerous sensors located on the truck or trailer, as illustrated schematically in FIG. 9. The microcontroller then uses this information to send control information to various systems which are included as a part of the truck or trailer.

For instance, the tailgate 20 generally includes a latch position sensor 66 as noted above. Likewise, the air suspension typically includes an air pressure sensor 68 for determining the air pressure within the air suspension. A tarp position sensor 70 is included. A power take-off sensor 72 is included for determining the operating state of the power take-off 56, and a hydraulic pump sensor 74 is also included. The microcontroller receives information from each of these sensors.

In addition, the truck or trailer also includes a first inclinometer 76 which is attached to the dump bed 10. This first inclinometer 76 measures the longitudinal tip angle and the lateral roll angle of the dump bed 10. The truck or trailer also includes a second inclinometer 78 which is attached to the lower portion 24 of the truck or truck trailer. This second inclinometer 78 measures the longitudinal levelness and transverse levelness of the truck or truck trailer lower portion 24. The control system microcontroller receives tip angle and roll angle information from the first inclinometer 76 as well as longitudinal levelness and transverse levelness from the second inclinometer 78.

Preferably according to the present disclosure, information received by the control unit 60 from any of the aforementioned sensors may be selectively displayed on the video monitor associated with the control unit 60. For instance, a person using the control system may use the human machine interface selectors to view latch position information on the video monitor. Alternatively, air pressure information, tarp position information, power take-off information, pump condition information, tip angle and roll angle information, and/or longitudinal levelness and transverse levelness may be viewed on the video monitor.

Also, according to the present disclosure, the control unit microcontroller may be programmed to display a warning message on the video monitor if the microcontroller receives information from one or more sensors which exceeds a pre-determined threshold indicating an unsafe operating condition. The microprocess may also activate an audible (or other) alarm to further warn of the unsafe condition. Further, if the microcontroller receives sensor information from indicating an unsafe operating condition, the microcontroller may send control information which prevents operation of the hoist 46 until the unsafe condition is corrected.

For instance, the control unit 60 may send control information to disengage the power take-off 56 from the hydraulic pump 50 (thereby preventing raising of the hoist), and display a warning message on the video monitor, if the control unit 60 receives information from the latch position sensor 66 indicating that the tailgate latch 22 is in an unlocked position. Similarly, the control unit 60 may send control information to disengage the power take-off 56 from the hydraulic pump 50, and display a warning message on the video monitor, if the control unit 60 receives information from the tarp position sensor 70 indicating that the tarp is in an extended position.

The control unit 60 may also send control information to disengage the power take-off 56 from the hydraulic pump 50, and display a warning message on the video monitor, if the control unit 60 receives information from the power take-off sensor 72 indicating that the hydraulic pump 50 is not operating. Further, the control unit 60 may send control information to disengage the power take-off 56 from the hydraulic pump 50, and display a warning message on the video monitor, if the control unit 60 receives information receives information the at least one suspension pressure sensor 68 indicating that the air suspension air pressure is either below a predetermined minimum air pressure or above a predetermined maximum air pressure.

Of particular importance, the control unit 60 may also prevent operation of the hoist 46 under conditions which may cause truck or trailer to be become unstable and either tip over (forwards or backwards) or roll over (sideways). The conditions which may cause the truck or trailer to tip over or roll over will depend upon a combination of factors: the longitudinal and lateral levelness of the truck, the tip and roll angles of the dump bed 10, the size of the load in dump bed 10, and the degree to which the dump bed 10 is raised by the hoist 46.

Thus, according to the present disclosure, the control unit 60 may receive hydraulic pressure information from at least one pressure sensor 80 which measures hydraulic cylinder pressure within the hoist. Using this information, the control unit 60 calculates a percent of cylinder load capacity based upon the hydraulic pressure information. The control unit 60 then determines a maximum safe dump bed tip angle based upon longitudinal levelness information from the second inclinometer 78, transverse levelness information also from the second inclinometer 78, and the percent of cylinder load capacity. Based upon this calculation, the control unit 60 then sends control information to stop flow of hydraulic fluid through the hydraulic fluid control valve 52, and optionally display a warning message on the video monitor, if the tip angle of the dump bed exceeds the maximum safe dump bed tip angle.

In addition, the control unit 60 may also send control information to disengage the power take-off 56 from the hydraulic pump 50, and display a warning message on the video monitor, if the control unit 60 receives information from the second inclinometer 78 indicating that either the longitudinal levelness or the transverse levelness of the truck or truck trailer lower portion 24 exceeds a predetermined maximum longitudinal levelness or maximum transverse levelness.

Further, in some instances, one or more cameras may be included. For instance, a backup camera 82 may be attached to the rear portion 14 of the dump bed 10 and positioned for observing an area behind the truck or truck trailer. A load camera 84 may also be attached to the front portion 12 of the dump bed 10 and positioned for observing a location within the dump bed 10. Images from both the backup camera 82 and the load camera 84 are preferably sent to and received by the control unit 60. Moreover, images from both the backup camera 82 and the load camera 84 may be selectively displayed on the video monitor.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A control system for a dump truck or a dump trailer comprising:
a truck or a truck trailer;
a dump bed having a front portion, a rear portion, a bed floor and a plurality of sidewalls attached to the bed floor, the dump bed being pivotally attached to a lower portion of the truck or truck trailer;
a dump bed hydraulic hoist comprising a plurality of telescoping hoist sections, the hoist having a first end attached to the truck or truck trailer and a second end attached to the dump bed, wherein the hoist is movable between a retracted position and an extended position in which the dump bed is tipped to facilitate load dumping;
a hydraulic pump in flow communication with a hydraulic fluid control valve for supplying pressurized hydraulic fluid to the hoist, the pump further including a pump sensor for determining the operating state of the pump;
a power take-off for selectively transferring power from a truck powertrain to the hydraulic pump, the power take-off having a valve to engage with and disengage from the hydraulic pump and further including a power take-off sensor for determining the operating state of the power take-off;
a first inclinometer attached to the dump bed for determining a tip angle and a roll angle of the dump bed;
a second inclinometer attached to the lower portion of the truck or truck trailer for determining longitudinal levelness and transverse levelness of the truck or truck trailer lower portion;
an integrated hoist electronic control unit for receiving sensor information and sending control information based upon the sensor information received, wherein the control unit receives information from the pump sensor, the first inclinometer, and the second inclinometer, and wherein the control unit sends control information to the hydraulic fluid control valve;
a primary hoist human machine interface capable of receiving information from and sending information to the control unit, the primary human machine interface having a video monitor for displaying information received from the control unit and a plurality of controls for sending information to the control unit.

2. The control system of claim 1, wherein tip angle information and roll angle information for the dump bed are selectively displayed on the video monitor.

3. The control system of claim 1, wherein the control unit sends control information to disengage the power take-off from the hydraulic pump, and optionally display a warning message on the video monitor, if the control unit receives information from the second inclinometer indicating that either the longitudinal levelness or the transverse levelness of the truck or truck trailer lower portion exceeds a predetermined maximum longitudinal levelness or maximum transverse levelness.

4. The control system of claim 1, further comprising at least one pressure sensor for determining a hydraulic cylinder pressure within the hoist, wherein the control unit receives hydraulic pressure information from the at least one pressure sensor and calculates a percent of cylinder load capacity based upon the hydraulic pressure information.

5. The control system of claim 4, wherein the control unit determines a maximum safe dump bed tip angle based upon the longitudinal levelness information, the transverse levelness information, and the percent of cylinder load capacity; and
wherein the control unit sends control information to stop flow of hydraulic fluid through the hydraulic fluid control valve, and optionally display a warning message on the video monitor, if the tip angle of the dump bed exceeds the maximum safe dump bed tip angle.

6. The control system of claim 1, wherein the control unit sends control information to disengage the power take-off from the hydraulic pump, and optionally display a warning message on the video monitor, if the control unit receives information from the power take-off sensor indicating that the hydraulic pump is not operating.

7. The control system of claim 1, further comprising a tailgate pivotally attached to the rear portion of the dump bed, the tailgate having a latch which is movable between a locked position and an unlocked position and a latch position sensor for determining the position of the tailgate latch,
wherein the control unit receives information from the pump sensor and sends control information to disengage the power take-off from the hydraulic pump, and optionally display a warning message on the video monitor, if the control unit receives information from the latch position sensor indicating that the tailgate latch is in an unlocked position.

8. The control system of claim 1, further comprising
a tarp extendable over the dump bed;
at least one elongate arm attached to an end of the tarp;
a tarp motor for moving the elongate arm and the tarp from a retracted position to an extended position; and
a tarp position sensor for determining the position of the tarp arm,
wherein the control unit receives tarp position information from the tarp position sensor and sends control information to the tarp motor.

9. The control system of claim 8, wherein the control unit sends control information to disengage the power take-off from the hydraulic pump, and optionally display a warning message on the video monitor, if the control unit receives information from the tarp position sensor indicating that the tarp is in an extended position.

10. The control system of claim 1, wherein the truck or truck trailer includes an air suspension for suspending the lower portion of the truck or truck trailer,
wherein the control system further comprises at least one suspension pressure sensor for determining the air suspension air pressure, and
wherein the control unit receives air pressure information from the at least one suspension pressure sensor.

11. The control system of claim 10, wherein the control sends control information to disengage the power take-off from the hydraulic pump, and optionally display a warning message on the video monitor, if the control unit receives information the at least one suspension pressure sensor indicating that the air suspension air pressure is either below a predetermined minimum air pressure or above a predetermined maximum air pressure.

12. The control system of claim 1, further comprising a backup camera attached to the rear portion of the dump bed and positioned for observing an area behind the truck or truck trailer, wherein the control unit receives images from the backup camera and the images are selectively displayed on the video monitor.

13. The control system of claim 1, further comprising a load camera attached to the front portion of the dump bed and position for observing a location within the dump bed, wherein the control unit receives images from the load camera and the images are selectively displayed on the video monitor.

14. The control system of claim 1, further comprising a secondary hoist human machine interface capable of wirelessly receiving information from and wirelessly sending information to the control unit, the secondary human machine interface having a plurality of controls for sending information to the control unit.
